(19) United States
(12) Patent Application Publication
(10) Pub. No.: US 2024/0029030 A1
(43) Pub. Date: Jan. 25, 2024

(54) Method, system and computer-readable medium for initializing and operating a purpose clock

(71) Applicant: Wayne Michael Anderson, Chicago, IL (US)

(72) Inventor: Wayne Michael Anderson, Chicago, IL (US)

(21) Appl. No.: 17/814,510

(22) Filed: Jul. 22, 2022

(51) Int. Cl. G06Q 10/10

(52) U.S. Cl. CPC G06Q 10/1097

(57) ABSTRACT

In one embodiment, a computer implemented method, system, and computer-readable medium comprising: receiving data with a reference to a routine object from a client onto a server; checking the presence of a client account associated with the client, and creating the client account if one does not exist; querying a routine data store connected to the server using the reference to the routine object; retrieving from the routine data store the routine object associated to the routine object reference in the data input; copying a routine template object from the routine object retrieved, and adding the routine template object to the routine template data store associated with the client account; identifying if the routine template object being copied is typed as an everyday habit routine, and if not, adding to the routine template data store associated to the client account a predefined routine template object from a routine object that is typed as an everyday habit routine; and analyzing a daily agenda report data store associated with the client account to determine the presence of a daily agenda report object for the same day at the time of analysis, and if not, creating the daily agenda report object for the same day at the time of analysis; wherein the daily agenda report object includes a plurality of said agenda items with a plurality of agenda item types aggregated together and sorted by their start time.

### BACKGROUND

The present invention relates to novel methods, systems and computer-readable mediums for creating and following multiple routines at once. More particularly, the invention relates to a routine-driven purpose clock capable of perpetually presenting a continuously updating countdown to the very next agenda item from a plurality of routines followed by a user.

When one looks at a typical clock, there are no purposeful, specific contexts tied to the times presented by the hands of the clock. A clock in time zone A will always show the same time as another clock in the same time zone A. We make our schedule from the time we are given; this schedule acts as a contextual overlay to the time presented by the typical clock. The clock gives us the current times, and we apply our schedule to that time. In this construct, the time is given first and dictates our schedule. The present invention seeks to reverse this priority of consideration and place initial focus on our purposes, then from this basis of purpose, provide a perpetual countdown, or measure of time—similar, but different to a regular clock—to the very next action as required by the plurality of routine objects followed by the user.

Until now, it has been hard to quantify how close we are to following our intentions, or purposes. What are the opportunity costs for not acting towards our goals?. Very often, at any given moment in time, we are doing things that we should not be doing (eating junk food), and not doing things that we should be doing (cooking good food). Yet, in defense of humanity, at any given moment, it has not always been clear what we should be doing next when trying to juggle multiple routines at once. How do we know what to do next in order to reach our goals? And, how do we know we are on pace? How do we know if the routines we have incorporated into our lives are helping us? Understanding where we are at and where we are going within a routine has typically involved an unnecessary expenditure of cognitive power designing a program or routine. More time and attention is consumed needing to understand where we are at in the routine. These challenges become more pronounced when handling many routines at once. Embodiments of the current invention are presented to address these questions.

### BRIEF SUMMARY OF THE INVENTION

A method, system, program and computer-readable medium for initializing and perpetually operating a routine purpose clock where time is presented as a countdown to the very next purposeful agenda item a user has selected to engage with. Particular embodiments ultimately provide the ability for a user to follow multiple human action routines from a plurality of publishers who have the expertise for creating programs for human routines.

### BRIEF DESCRIPTION OF THE DRAWINGS

Some embodiments of the present invention are illustrated as an example and are not limited by the figures of the accompanying drawings, in which like references may indicate similar elements and in which

FIG. 1 depicts a system diagram

FIG. 2 shows steps of method implementation for example embodiment

FIG. 3 further shows steps of method implementation for example embodiment

FIG. 4 further shows steps of method implementation for example embodiment

FIG. 5 further shows steps of method implementation for example embodiment

FIG. 6 illustrates the database collection and sub-collection data store model for routines

FIG. 7 shows a routine object diagram template

FIG. 8 illustrates the routine data model

FIG. 9 depicts additional data objects used to drive specific routine types

FIG. 10 illustrates the database collection and sub-collections for client accounts with routine template data stores

FIG. 11 depicts an abstract view of how the invention organizes routine moments into daily agenda lists

FIG. 12 depicts the agenda item log and outcome log sub-collections of user's routine templates collection

FIG. 13 shows a daily agenda item object diagram

FIG. 14 illustrates a client device view

FIG. 15 shows a process flow for determining the very next item displayed on main view

### DETAILED DESCRIPTION OF EXAMPLE EMBODIMENTS

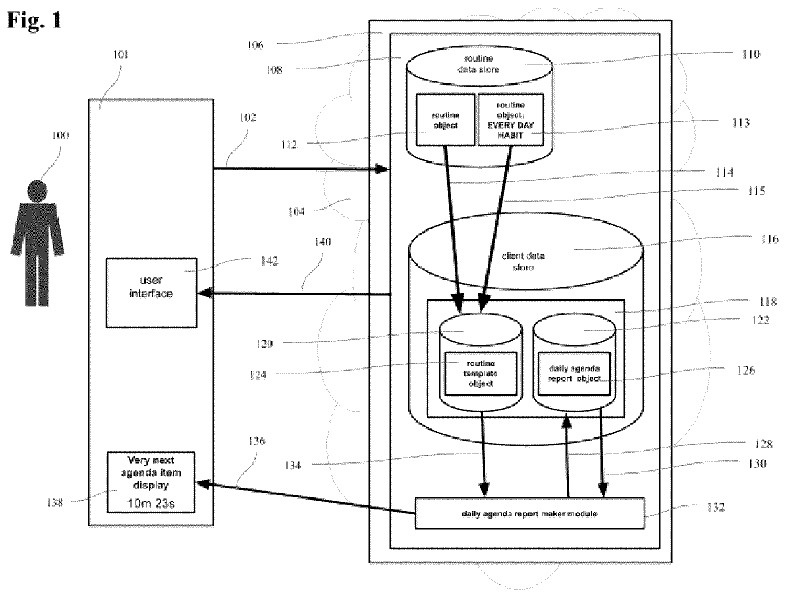

Referring to FIG. 1, a detailed discussion of the major components of the invention will be discussed. A server 108 operated within a cloud computing environment 106 receives onto it, via network 104, a data input 102 from a client 101. In one embodiment of the invention the client 101 is being used by a human user 100. In other embodiments, another computing entity could be using client 101 to send the data input 102 to server 108. The data input 102 contains a reference to a routine object 112 located in a routine data store 110. The routine data store is connected to the server 108, and serves as a source of truth for a plurality of types of the routine objects 112.

This disclosure contemplates any suitable network 104. As an example and not by way of limitation, one or more portions of network 104 may include an ad hoc network, an intranet, an extranet, a local area network (LAN), a virtual private network (VPN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, or a combination of two or more of these. Network 104 may include one or more networks 104.

In particular embodiments, Google's Firebase cloud computing environment is used to implement cloud computing environment 106. Other computing environments can be used, like AWS, or other computing systems. Cloud computing environment 106 provides real-time functionality for the routine data store 110, for a client data store 116, a daily agenda report data store 120, and a routine template data store 122. In this case, real-time functionality means as changes occur in the data stores, the server 108 updates the user interface 138 with these changes. Both the daily agenda report data store 122 and the routine template data store 120 are associated, as child sub-collections of a client account 118 that is stored in the client data store 116. The client account 118 is associated with the client 101. In particular embodiments, one client account 118 is created for each unique client 101 connecting to server 108.

In particular embodiments, user 100 may be an individual (human user), an entity (e.g., an enterprise, business, or third-party application), or a group (e.g., of individuals or entities). Moreover, although FIG. 1 illustrates a particular number of users 100, client system 101, network 104, and servers 108, this disclosure contemplates any suitable number of users 100, clients 101, networks 104, and servers 108.

In particular embodiments, when the data input 102 from the client 101 is received onto the server 108, a check is performed on the client data store 116 for the presence of the client account 118 associated with client 101, and if one does not exist, the client account 118 is created and stored in client data store 116.

Continuing with FIG. 1, the server 108 provides the client 101 with instructions for implementing a daily agenda report maker module 132. These instructions are executed by the client 101, and in some particular embodiments by the server 108 computing environment each day the first time the client 101 connects to the server 108. During this execution, the daily agenda report maker module 132 checks 128 the daily agenda report data store 122 to see if a daily agenda report 126 for that day exists, and if it does not exist, it will create the daily agenda report 126 and add it to the daily agenda report data store 122.

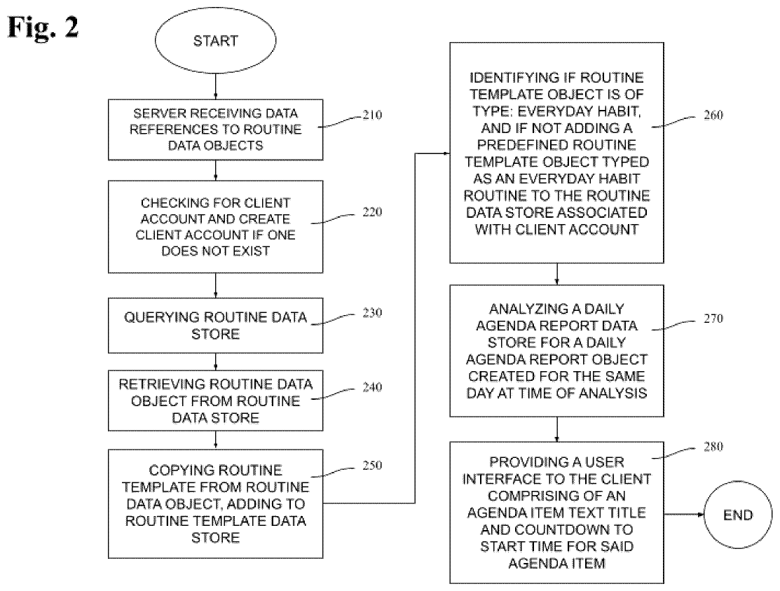

Referring to FIG. 1-2, in example embodiments, the method implementation is as follows in particular embodiments:
FIG. 2, Step 210—receiving data input 102 with a reference to a routine object 112 from a client 101 onto a server 108. The data input 102 could be a result of a user activating a QR-code where the link contains instructions for the server 108 to process the incoming data input 102. Or, another example could be if a user was navigating a routine search engine tool, and hit the “Subscribe” button for a given routine. These links could include one or more references to routine objects 112.
Step 220—checking the presence of a client account 118 in client data store 116, and creating the client account if one does not exist
Step 230—querying a routine data store 110 connected to the server 108 using the data input 102 that includes the reference to the routine object 112
Step 240—retrieving from the routine data store 110 the routine object 112 associated to the routine object reference in the data input 102
Step 250—copying (FIG. 1, 114) a routine template object 124 from the routine object retrieved in Step 240, and adding the routine template object 124 to the routine template data store 120 associated with the client account 118
Step 260—identifying if the routine template object 124 being copied is typed as an everyday habit routine, and if not, adding (FIG. 1, 115) a predefined routine template object from a routine object 113 that is typed as an everyday habit routine to the routine template data store 120 associated to the client account 118. This is a key step for keeping the purpose clock running on a perpetual basis with current, active countdowns to agenda items being displayed on a routine, consistent, daily basis. For particular embodiments, the predefined everyday habit routine template object is a drink 10 glasses of water per day routine. The resulting 10, evenly spaced agenda items spanning throughout the day, contributes to the perpetual behavior of the purpose clock.
Step 270—analyzing a daily agenda report data store 122 associated with the client account 118 to determine the presence of a daily agenda report object 126 for the same day at the time of analysis, and if not, creating the daily agenda report object 126 for the same day at the time of analysis.
   The steps depicted in FIG. 2 may happen in the order just described, or may occur in a different order based on the particular embodiment.

Referring to FIG. 1-2, the method further comprising in particular embodiments:
Step 280—providing a user interface 138 to the client comprising of an agenda item title text string for an agenda item scheduled to start next relative to the current time included in the current day's daily agenda report object 126, with said agenda item scheduled to start next relative to the current time, and a countdown clock to a start time for said agenda item.
   As examples, and not a limitation, the agenda item title may read “drink water” or “do push ups.”

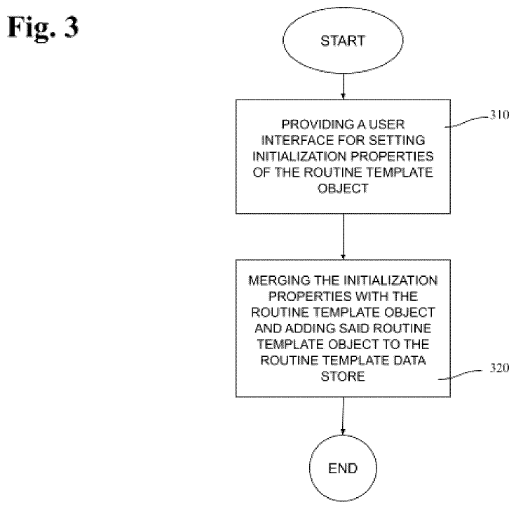

Referring to FIG. 3, the method further comprising in particular embodiments'
Step 310—providing a user interface 142 to the client 101 comprising of an input and a control element for setting an initialization property of the routine template object 124; and
Step 320—merging the initialization property with the routine template object 124 before adding the routine template object 124 to the routine template data store 120 associated with the client account 118.

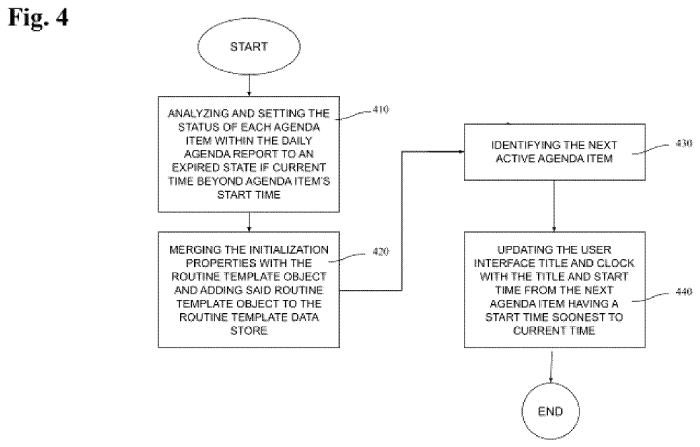

Referring to FIG. 4, the method further comprising in particular embodiments
Step 410—analyzing the daily agenda report object 126 to determine a status of each of the agenda items in the agenda report, and setting the status of each agenda item within the daily agenda report object 126 to an expired state if the current time has moved beyond the agenda item's start time;
Step 420—checking the daily agenda report object 126 for any remaining active agenda items with start times after the current time;
Step 430—identifying the next active agenda item with a start time soonest to the current time;
Step 440—updating the user interface 138 agenda item title and countdown clock with the title and start time from the next agenda item having a start time soonest to the current time
   Steps 410-440 together provide the perpetual characteristic of the purpose clock.

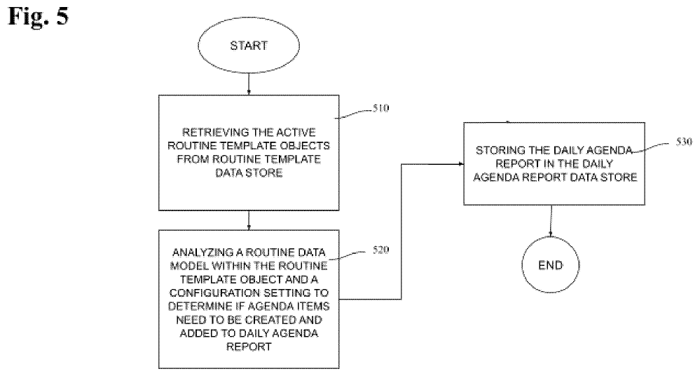

Referring to FIG. 5, the method further comprising in particular embodiments
Step 510—retrieving the routine template objects 124 that are in an active status from the routine template data store 120 associated with the client account 118;
Step 520—analyzing a routine data model within each of the retrieved routine template objects 124 and a configuration property in the client account 118, determining if one or more agenda items need to be created, and adding the created agenda items to the daily agenda report object 126;
Step 530—storing the daily agenda report object 126 in the daily agenda report data store 122 with a key set a daystamp (e.g. 2022-03-23)

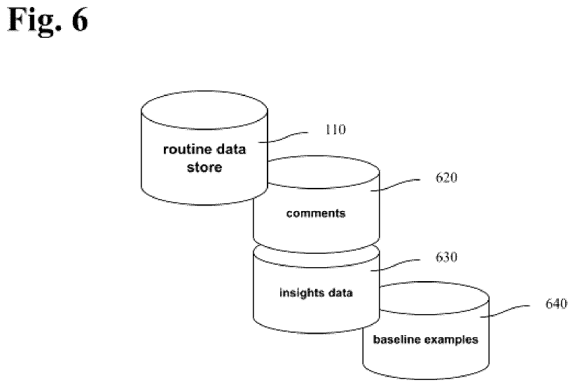

In particular embodiments, and not meant to be a limitation, the user interface 138 may provide additional functionality if the user 100 were to activate the very next item, or one of the next agenda items shown, by either tapping, or clicking, the item to review the outcome follow-up view. Using the outcome follow-up view, the user may provide outcome inputs and press a call to action button to submit the outcome inputs. The system saves the outcome object within the user and updates the baseline example data store (FIG. 6, 640) stored in routine data store 110.

Referencing FIG. 6, the routine objects are stored in the routine data store 110. The routine data store 110 is the source of truth for the invention's routine data. in particular embodiments, additional sub-collections may be added to the routine object 112 within the routine data store 110 to facilitate additional functionality not limited to:
A sub-collection data store for comments made by users relating to that specific routine object
A sub-collection data store for insights data rolled up by routine object 112, which could also include a sub-collection data store for baseline examples 640 for collecting anonymous outcome data

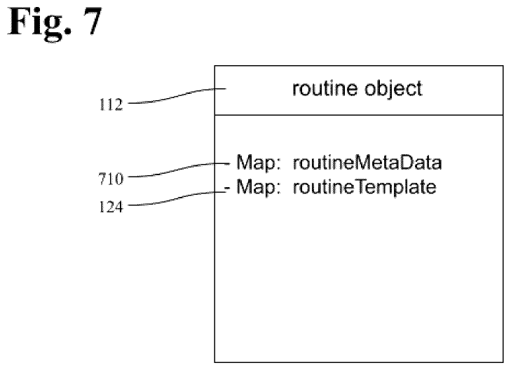

Referencing FIG. 7, the routine object 112 comprises an object map for routine metadata 710 and the routine template object 124. The routine metadata 710 comprises a plurality of data properties related to the routine object 112 as a whole. The routine metadata 710 can possibly include properties like, but not limited to those shown in Table 7.1 below:

TABLE 7.1
routine metadata examples (in camel case)

| | | | | |
|---|---|---|---|---|
| helpfulLinks | isFeatured | isPrivate | marketingContent | routineCode |
| routineFollowerCount | routineId | routineStatus | | |

Referencing FIG. 7, the routine template object 124 includes data that instructs and controls how the routine template object 124 gets processed by the daily agenda report maker module 132. All this information is encapsulated in one object, the routine template object 124, so that this single object can be cloned and distributed to other users in the exact same way; thus, enabling a normalized framework for outcome data baselines.

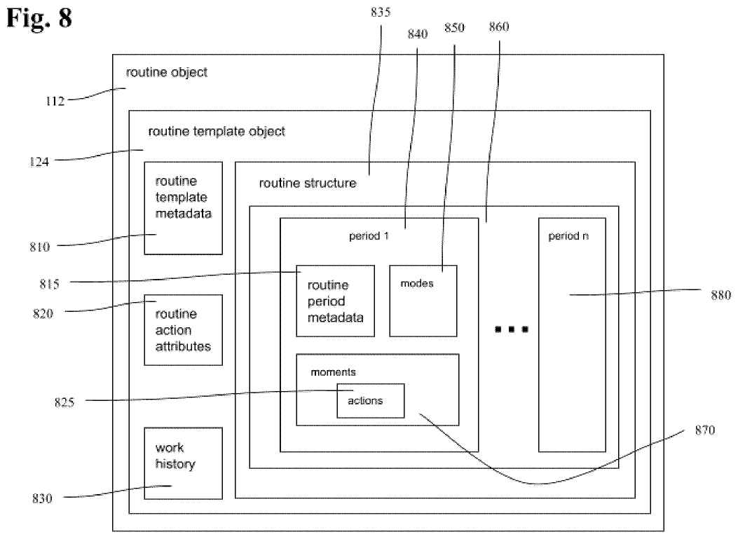

Referencing FIG. 8, in particular embodiments, each routine template object 124 comprises a plurality of data properties that together are referred to as a routine template metadata 810, a routine action attributes object map 820, a work history 830, and a routine structure 835. The routine template metadata 810 includes properties like, but not limited to those shown in Table 8.1 below.

TABLE 8.1
routine template metadata examples (shown in camel case)

| | | | | |
|---|---|---|---|---|
| dateCreated | iconImageBlack | iconImageGrey | intentMeanCategory | routineCycleCt |
| routineStatus | routineId | routinePublisherId | routineType | routineTitle |
| tags | | | | |

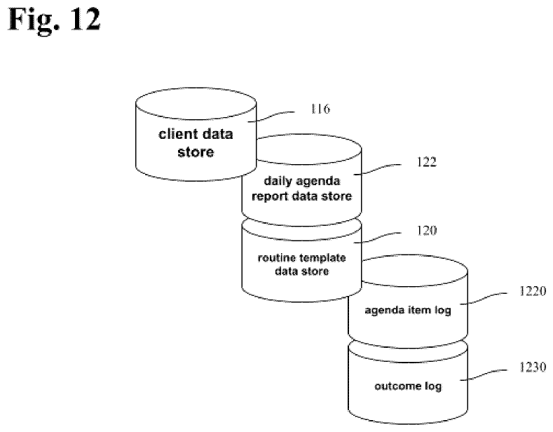

Referencing FIG. 8, in particular embodiments, the routine action attributes object map 820 holds information regarding the routine human actions used within the routine template object 124. The work history 830 is a data storage container object that will house and store information each time work is performed in a routine. The work history 840 can be referenced by other embodiments of the daily agenda report maker module 132 to enable dynamic scheduling of agenda items. The daily agenda report maker module 132 analyzes the work history 830, along with outcome data stored in an outcome log 1230 (See FIG. 12), and determines if the user 100 associated with client account 118 should work or rest on a given day for a given routine template object.

Referencing FIG. 8, in particular embodiments, the routine structure 835 is further comprised of period objects 860. The routine periods have a duration, usually of weeks, and enable periodization with the routine scheduling. Using weekly routine cycles aligns with the ISO week standard of time measurement across the globe. A plurality of data properties are together referred to a routine period metadata 815. The routine period metadata 815 includes properties like, but not limited to those shown in Table 8.2 below:

TABLE 8.2
routine period metadata examples (shown in camel case)

| | | | | |
|---|---|---|---|---|
| currentMode | desc | name | numWks | outcomeModes |
| seqNum | timesPerDay | type | workTitle | |

The routine periods may be further comprised of a modes object 850 and a moments object 825. The modes object 850 provides instructions to the daily agenda report maker module 132 for how to schedule the agenda items for a given routine template object 124. The routine structure 835 can have one or more modes available for the user 100 to select from for scheduling when and how often they work within a given routine Table 8.3 shows an example list of modes keys available in particular embodiments, and not limited to:

TABLE 8.3
routine modes - key names used to identify modes

| | | | | |
|---|---|---|---|---|
| USER_DEFINED_DOW | USER_DEFINED_DOM | DYNAMIC_EXERCISE | CHALLENGE_10 | CHALLENGE_20 |
| CHALLENGE_30 | CHALLENGE_40 | ALTERNATE_WORK_{—} | ALTERNATE_WORK_{—} | ALTERNATE_WORK_{—} |
| | | 1_REST_1 | 1_REST_2 | 2_REST_1 |
| ALTERNATE_WORK_{—} | EXERCISE_WORK_1 | EXERCISE_WORK_3 | EXERCISE_WORK_3 | EXERCISE_WORK_4 |
| 2_REST_2 | | | | |
| CESSATION_12_8 | CESSATION_10_4 | CESSATION_8_1 | LIST_DRAW | |

The period objects 840 use these mode keys to reference mode objects consisting of additional properties and data that instruct the daily agenda report maker module 132 on how to schedule the agenda items. In particular embodiments, the mode objects 850 will contain action objects 825. In other embodiments, the action objects 825 may be located within the mode objects 850. The disclosure here is meant to provide one possible example for how to implement particular embodiments.

The strength of the data model is its ability to model actions from different domains in a similar way. This means that an exercise routine, and a personal project routine are modeled in a similar structure. A resulting benefit is this can provide interesting user experiences that mix business process actions with personal, routine actions, like cooking or exercise tasks.

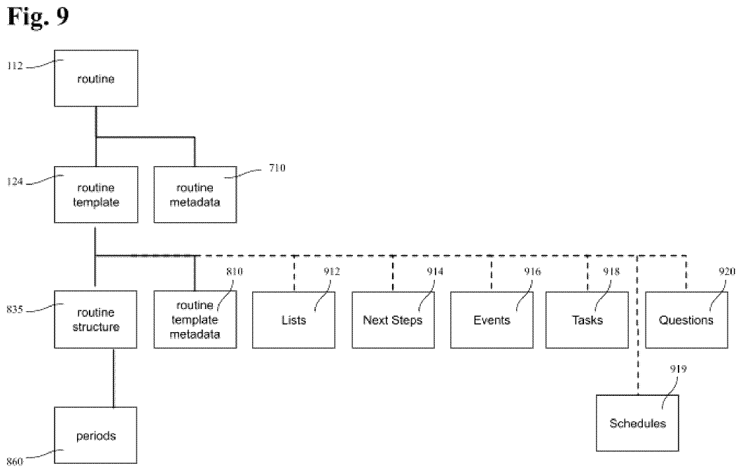

Referring to FIG. 9, for particular embodiments, additional data objects get created and added to the routine template object 124 to facilitate nuances between routine types. List draw routines, or routines where you draw content from a list routinely each week will use a Lists object 912 to store properties and instructions related to implementing the list draw routine. Work session routine types would have a next steps object 914, while the event follow-up routine types may have objects for events 916, tasks 918, and questions 920. Cessation routine types may have a schedules object 919. These routine types are just a few examples of a plurality of routine types enabled by particular embodiments.

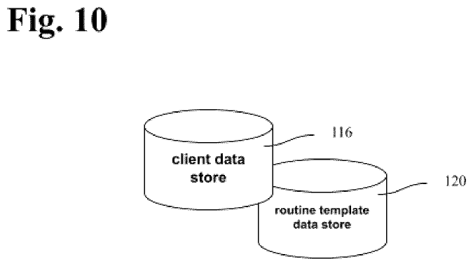

Referencing FIG. 10 and FIG. 2, routine template object 124 is copied/cloned in-full from routine object 112 to the client's routine template data store (FIG. 2, 250), which is a sub-collection to the client data store 116. (see FIG. 10)

The key for this new routine template document is auto-assigned by the cloud computing environment (i.e. Firebase)
EXAMPLE FIRESTORE REFERENCE PATH:
/clients/{id}/routineTemplates/{id2}/

Copying the routine template object 410 in-full allows the exact same routine template, or at least the latest version of the routine template to be reliably disseminated amongst the users of the invention, thereby providing a means to generate collective action outcome data grouped by routine template.

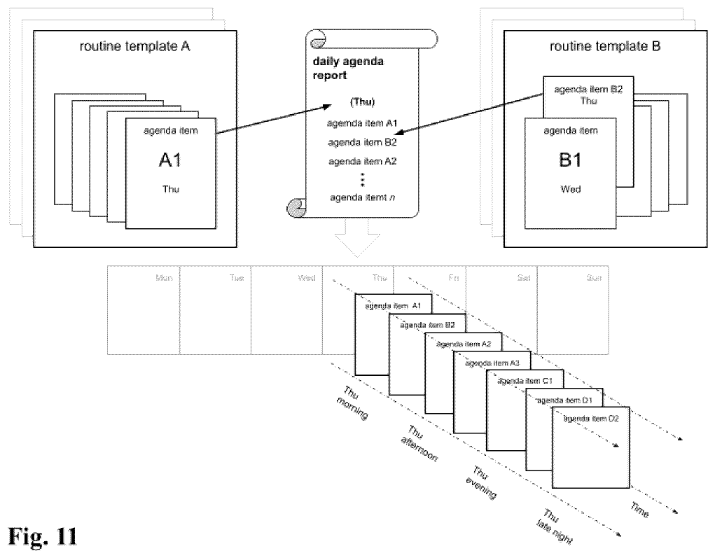

Referencing FIG. 1 and FIG. 11, for a particular embodiment, each time the user 100 activates server 108 using client 101 (see FIG. 1), the daily agenda report maker module 132 queries the routine template data store 120 for all active routine templates 335 subscribed to by the user. Then, based on rules, the daily agenda item list maker determines if any agenda items need to be added to the current day's daily agenda report object 126 (see FIG. 1).

Referencing FIG. 11, the diagram depicts an abstract view of how agenda items are organized on a common agenda item timeline during the daily agenda report creation process. The diagram depicts two active routine templates: routine template A and routine template B, each with its own unique routine structure 835. For this particular example, the current day is Thursday, therefore, the daily agenda item list maker 132 will only add agenda items to the common timeline if the rules and instructions provided by routine structure 835 when analyzed and determined that Thursday is a work day for this particular routine.

Still referring to FIG. 11, the diagram depicts agenda item A1 from routine template A and agenda item B2 from routine template B as being included in the daily agenda report for Thursday. In the bottom half of FIG. 11, the common agenda item timeline is depicted with all the relevant agenda items ordered across four different times of day: morning, afternoon, evening, late evening. More granularity can be applied to the timing of moments, mainly by prescribing a specific time for each to happen. Yet, a benefit can be gained by loosely collating, or scheduling, the moments based on the general time of day, and avoid overlapping moments, or requiring the user to commit to specific times, which can cause planning friction in the users routine development process. It should be noted that the invention's output is less concerned with agenda items being performed at specific times, but rather if they are being done at all within the given day and what are the results, or outcomes. This requirement for less granularity, or resolution, with agenda item start times provides more flexibility in schedules and allows for an interesting mix of actions throughout the day.

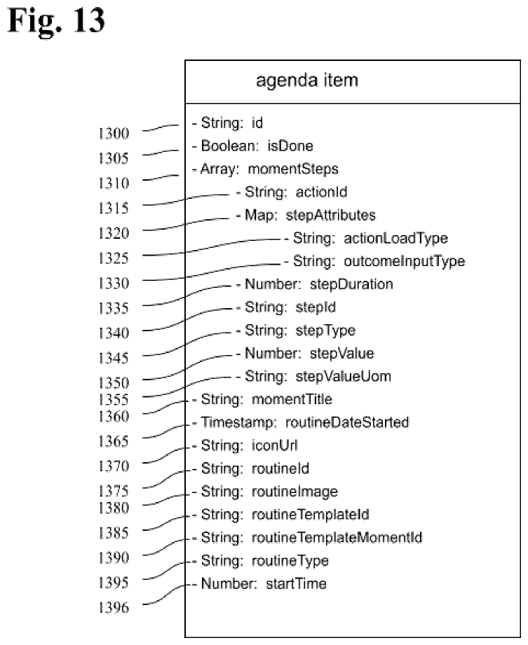

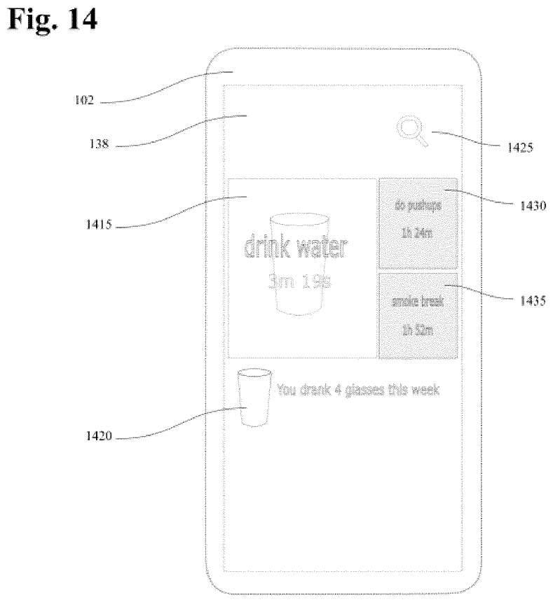

Referencing FIG. 12, whenever a new daily agenda report object 126 is newly created, the agenda items that are determined by the daily agenda report maker module 132 to be relevant for the given day, are copied and collated together into a single sub-collection for agenda item logs 1220 with an ISO day stamp key (i.e 2021-06-21). See the discussion of FIG. 13 for a detailed breakdown of an agenda item object. At this same time, all the agenda items objects are copied to the agenda item log 1230. This outcome log is used by the very next item stats component 1415 (FIG. 14), which will be discussed shortly. These object creations are done in parallel to other processes for particular embodiments.

Below are sample database calls for the daily agenda report object 126 and the agenda item log 1220
EXAMPLE FIRESTORE REFERENCE PATH:
/users/{id}/dailyAgendaReports/{id2}/
   key: {dayStamp}
EXAMPLE FIRESTORE REFERENCE PATH:
/users/{id}/routineTemplates/{id2}/agendaItemLog/{id3}
   Composite key: {dayStamp} and {routineTemplateMomentId}

Referencing FIG. 13, for particular embodiments, an agenda item object comprising, but not limited to
1300—id. String—a unique id that represents the agenda item within the system
1305—isDone: Boolean—if the agenda item has been completed, this would be true. The default value is false.
1310—momentSteps: Array—
   1315—actionId: String—a unique id that represents a specific action within the system
   1320—stepAttributes: Map—
      1325—actionLoadType: String—this determines how units of measure are shown for actions involving loads
      1330—outcomeInputType: String—this determines how outcome inputs are labeled with units of measure
   1335—stepDuration: Number—this value defines how long the agenda item takes to complete based on seconds.
   1340—stepId: String—this is a unique id that represents the step object within the system
   1345—stepType: String—this determines how steps 320 are shown to the user
   1350—stepValue: Number—this is the key outcome value being collected/measured
   1355—stepValueUom: String—this defines the unit of measure for the stepValue above
1360—momentTitle: String—the title of the agenda item
1365—mutineDateStarted: Timestamp—the date when the routine was started by the user
1370—iconUrl: String—the URL to a icon resource that represents the action being performed
1375—routineId: String—the unique routine id from which this agenda item was made
1380—routineImage: String—the URL to an image resource that represents the routine being performed
1385—routineTemplateId: String—the unique id of the routine template from which this agenda item was made
1395—routineType: String—a key property in determining how routine template objects are processed into agenda items and outcome data points
1396—startTime: Number—UNIX timestamp time when the agenda item reaches its READY state.

Referencing FIG. 14, In particular embodiments, the user interface 138 may show a very next agenda item display FIG. 14 shows an example of what the client 102 device may look like. This very next agenda item display 138 shows a continuous countdown to, at least, the very next agenda item in the daily agenda item list 1415. Other functionality, like a search icon 1425 to find more routines to subscribe to may be shown. Agenda items can be in one of six states: READY, NEXT1, NEXT2, NEXT3, ACTIVE, EXPIRED. As shown in FIG. 14, three agenda items are shown: 1415 (NEXT1), 1430 (NEXT2) & 1435 (NEXT 3). It's up to one skilled in the art how many agenda items to show; yet, the main purpose of the very next agenda item display is to call attention to the very next agenda item, so element 1415 at least should be shown within user interface 138. When the user 100 selects the very next item 1415, or either of the other two next agenda items 1430 & 1435, by either tapping, clicking, or any other means of selecting, an outcome view can be displayed to collect outcome data related to the routine template object 124 and routine object 112.

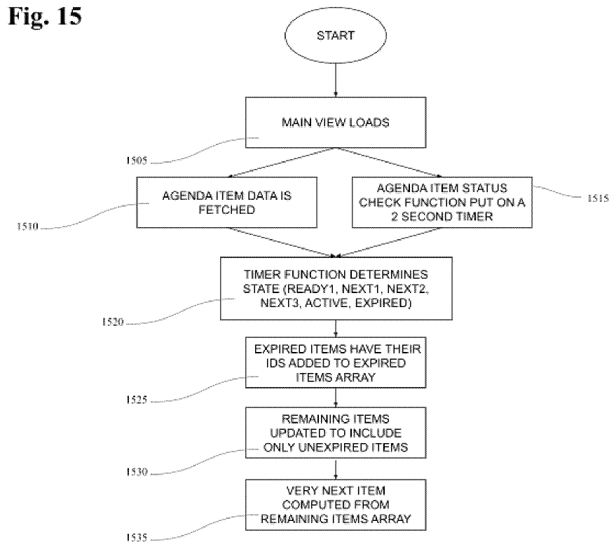

Referencing FIG. 15, the next discussion will focus on how the very next agenda item is determined. The following assumes those skilled in the art are using a real-time development framework, like Vue or React, to implement the following logic within the main view 136. There are numerous ways that the very next agenda item could be determined. The following discussion is just one approach provided as an example and not as a limitation:
1505: Main view loads
1510: Main view calls function to fetch the agenda item data array and sort the data by start time, ascending.
1515: Main view simultaneously starts a timer that for a function to run every 2 seconds
1520: Timer function from step 1515 executes the following rules on each agenda item object fetched in step 1505 to determine the state of each agenda item. These determined states are stored in an array.
   READY: If less than 3 minutes past start time
   EXPIRED: If more than 3 minutes past start time, or item is done.
   NEXT1: If this item is the very next item
   NEXT2: If the NEXT2 position has not already been filled, and this item is not done
   NEXT3: If the NEXT3 position has not already been filled, and this item is not done
1525: Same timer function then takes the states array created in step 1520 and for each agenda item determined to be EXPIRED, that agenda item's id is added to the expired items array.
1530: Once the expired items array from 1525 is updated, the system updates the remaining items array so that only unexpired items are in the remaining items array.
1535: Once the remaining items array from 1530 is updated, the system computes what the very next agenda item is by filtering for the next item that is not done, and its start time (plus 3 minutes for the READY state) is still in the future.

Referencing FIG. 14, each time a new very next agenda item is determined, the main view updates the items in positions 1415, 1430 and 1435 shown in FIG. 14. Also, a stats and metrics view 1420 for the very next agenda item in the NEXT1 or READY positions is updated to reflect stats associated to the new very next agenda item 1415.

What is claimed is:

1. A computer implemented method, comprising:
receiving data with a reference to a routine object from a client onto a server;
checking the presence of a client account associated with the client, and creating the client account if one does not exist;
querying a routine data store connected to the server using the reference to the routine object;
retrieving from the routine data store the routine object associated to the routine object reference in the data input;
copying a routine template object from the routine object retrieved, and adding the routine template object to the routine template data store associated with the client account;
identifying if the routine template object being copied is typed as an everyday habit routine, and if not, adding to the routine template data store associated to the client account a predefined routine template object from a routine object that is typed as an everyday habit routine; and
analyzing a daily agenda report data store associated with the client account to determine the presence of a daily agenda report object for the same day at the time of analysis, and if not, creating the daily agenda report object for the same day at the time of analysis;
wherein the daily agenda report object includes a plurality of said agenda items with a plurality of agenda item types aggregated together and sorted by their start time.

2. The method of claim 1, further comprising:
providing a user interface to the client comprising of an agenda item title text string for an agenda item included in the daily agenda report object, with said agenda item scheduled to start next relative to the current time, and a countdown clock to a start time for said agenda item;

3. The method of claim 1, further comprising:
providing a user interface to the client comprising of an input and a control element for setting an initialization property of the routine template object; and
merging the initialization property with the routine template object before adding the routine template object to the routine template data store associated to the client account,

4. The method of claim 1, further comprising:
analyzing the current day's daily agenda report object to determine a status of each of the agenda items in the daily agenda report object, and setting the status of each agenda item within the daily agenda report object to an expired state if the current time has moved beyond the agenda item's start time;
checking the daily agenda report object for any remaining active agenda items with start times after the current time;
identifying the next active agenda item with a start time soonest to the current time; and
updating the user interface display of agenda item title and countdown clock with the title and start time from the next agenda item having a start time soonest to the current time.

5. The method of claim 1, wherein creating the daily agenda report comprises of:
retrieving the routine template objects that are in an active status from the routine template data store associated with the client account;
analyzing a routine data model within each of the retrieved routine template objects and a configuration property in the client account, and determining if one or more agenda items need to be created, and adding the created agenda items to the daily agenda report object;
storing the daily agenda report in the daily agenda report data store.

6. The method of claim 1, wherein the routine template object has instructions that when executed by a computer performs the step of:
associating the routine template object to a routine publisher.

7. One or more computer-readable non-transitory storage media embodying software that is operable when executed to:
receiving data with a reference to a routine object from a client onto a server;
checking the presence of a client account associated with the client, and creating the client account if one does not exist;
querying a routine data store connected to the server using the reference to the routine object;
retrieving from the routine data store the routine object associated to the routine object reference in the data input;
copying a routine template object from the routine object retrieved, and adding the routine template object to the routine template data store associated with the client account;
identifying if the routine template object being copied is typed as an everyday habit routine, and if not, adding to the routine template data store associated to the client account a predefined routine template object from a routine object that is typed as an everyday habit routine; and
analyzing a daily agenda report data store associated with the client account to determine the presence of a daily agenda report object for the same day at the time of analysis, and if not, creating the daily agenda report object for the same day at the time of analysis;
wherein the daily agenda report object includes a plurality of said agenda items with a plurality of agenda item types aggregated together and sorted by their start time.

8. The computer-readable non-transitory storage media embodying software that is operable when executed of claim 7, further executing:
providing a user interface to the client comprising of an agenda item title text string for an agenda item included in the daily agenda report object, with said agenda item scheduled to start next relative to the current time, and a countdown clock to a start time for said agenda item.

9. The computer-readable non-transitory storage media embodying software that is operable when executed of claim 7, further executing:
providing a user interface to the client comprising of an input and a control element for setting an initialization property of the routine template object; and
merging the initialization property with the routine template object before adding the routine template object to the routine template data store associated with the client account.

10. The computer-readable non-transitory storage media embodying software that is operable when executed of claim 7, further executing:
analyzing the current day's daily agenda report object to determine a status of each of the agenda items in the daily agenda report object, and setting the status of each agenda item within the daily agenda report object to an expired state if the current time has moved beyond the agenda item's start time;
checking the daily agenda report object for any remaining active agenda items with start times after the current time;
identifying the next active agenda item with a start time soonest to the current time; and
updating the user interface display of agenda item title and countdown clock with the title and start time from the next agenda item having a start time soonest to the current time.

11. The computer-readable non-transitory storage media embodying software that is operable when executed of claim 7, further executing:
retrieving the routine template objects that are in an active status from the routine template data store associated with the client account;
analyzing a routine data model within each of the retrieved routine template objects and a configuration property in the client account, and determining if one or more agenda items need to be created, and adding the created agenda items to the daily agenda report object;
storing the daily agenda report in the daily agenda report data store.

12. The computer-readable non-transitory storage media embodying software that is operable when executed of claim 7, further executing:
associating the routine template object to a routine publisher.

13. A system comprising one or more processors, and a memory coupled to the processors comprising instructions executable by the processors, the processors being operable when executing the instructions for:
receiving data with a reference to a routine object from a client onto a server;
checking the presence of a client account associated with the client, and creating the client account if one does not exist;
querying a routine data store connected to the server using the reference to the routine object;
retrieving from the routine data store the routine object associated to the routine object reference in the data input;
copying a routine template object from the routine object retrieved, and adding the routine template object to the routine template data store associated with the client account;
identifying if the routine template object being copied is typed as an everyday habit routine, and if not, adding to the routine template data store associated to the client account a predefined routine template object from a routine object that is typed as an everyday habit routine; and
analyzing a daily agenda report data store associated with the client account to determine the presence of a daily agenda report object for the same day at the time of analysis, and if not, creating the daily agenda report object for the same day at the time of analysis;
wherein the daily agenda report object includes a plurality of said agenda items with a plurality of agenda item types aggregated together and sorted by their start time.

14. The system of claim 13, further executing the instructions for:
providing a user interface to the client comprising of an agenda item title text string for an agenda item included in the daily agenda report object, with said agenda item scheduled to start next relative to the current time, and a countdown clock to a start time for said agenda item.

15. The system of claim 13, further executing the instructions for:
providing a user interface to the client comprising of an input and a control element for setting an initialization property of the routine template object; and
merging the initialization property with the routine template object before adding the routine template object to the routine template data store associated to the client account.

16. The system of claim 13, further executing the instructions for:
analyzing the current day's daily agenda report object to determine a status of each of the agenda items in the daily agenda report object, and setting the status of each agenda item within the daily agenda report object to an expired state if the current time has moved beyond the agenda item's start time;
checking the daily agenda report object for any remaining active agenda items with start times after the current time;
identifying the next active agenda item with a start time soonest to the current time; and
updating the user interface display of agenda item title and countdown clock with the title and start time from the next agenda item having a start time soonest to the current time.

17. The system of claim 13, further executing the instructions for:
retrieving the routine template objects that are in an active status from the routine template data store associated with the client account;
analyzing a routine data model within each of the retrieved routine template objects and a configuration property in the client account, and determining if one or more agenda items need to be created, and adding the created agenda items to the daily agenda report object;
storing the daily agenda report in the daily agenda report data store.

18. The system of claim 13, further executing the instructions for:
associating the routine template object to a routine publisher.
